(19) United States
(12) Patent Application Publication
(10) Pub. No.: US 2018/0002819 A1
(43) Pub. Date: Jan. 4, 2018

(54) METHOD FOR PREVENTING TANK CORROSION AT TANK PRESSURE RESISTANCE TESTING

(71) Applicant: IHI Corporation, Tokyo (JP)

(72) Inventor: Takeshi SAITOU, Tokyo (JP)

(73) Assignee: IHI Corporation, Tokyo (JP)

(21) Appl. No.: 15/545,942

(22) PCT Filed: Oct. 26, 2015
(86) PCT No.: PCT/JP2015/080053

§ 371 Date: Jul. 24, 2017

(30) Foreign Application Priority Data
Feb. 17, 2015 (JP) 2015-028146

(51) Int. Cl. C23F 11/00; G01M 3/02

(52) U.S. Cl. CPC C23F 11/00; G01M 3/02

(57) ABSTRACT

An inner surface of a tank 10 is formed by joining a large number of metal plates 21, 23 and 25 to one another by welding. Before injecting pressure resistance testing water into an inside of the tank 10 in order to test pressure resistance of the tank 10, a corrosion inhibitor 31 is applied to welds 27 between the metal plates 21, 23 and 25 on a bottom part of the tank 10. A total bottom part area A1 of the welds 27 to be applied with the corrosion inhibitor 31 on the bottom part of the tank 10 is made wider than a total non-bottom-part area A2 of the welds to be applied with the corrosion inhibitor 31 on the inner surface of the tank 10 other than the bottom part of the tank 10.

### TECHNICAL FIELD

The present disclosure relates to a method for preventing tank corrosion at the time of tank pressure resistance testing, the method serving for preventing corrosion of an inner surface of a tank due to microorganisms in pressure resistance testing water when the pressure resistance testing water is injected into the tank to test pressure resistance of the tank against the injected pressure resistance testing water.

### BACKGROUND ART

Heretofore, a large-capacity tank, which stores liquefied gas (for example, LNG: liquefied natural gas) and other liquids, is formed of a large number of metal plates. In other words, such a large number of the metal plates are joined to one another by welding, whereby the large-capacity tank is formed. Hence, a bottom surface and inner peripheral surface of the tank are formed of these metal plates. Each of these metal plates is formed, for example, of aluminum or an aluminum alloy.

Pressure resistance testing is performed for the tank thus formed. The pressure resistance testing is performed in a following procedure. Fresh water such as river water and groundwater or seawater is injected as pressure resistance testing water into an inside of the tank, and the inside of the tank is filled with the pressure resistance testing water. This state is maintained for a pressure resistance testing period (for example, 1 month). In the pressure resistance testing period, it is confirmed whether or not the pressure resistance testing water leaks from the inside of the tank to an outside thereof.

In the above-mentioned pressure resistance testing, in a state where the inside of the tank is filled with the pressure testing water (fresh water or seawater), welds between the metal plates corrode due to an influence of microorganisms present in the pressure resistance testing water. Oxide films are formed on surfaces of the respective metal plates, and accordingly, regions of the respective metal plates, where the oxide films are present, are not corroded by the microorganisms in the pressure resistance testing water. Meanwhile, the oxide films are not formed on the welds between the metal plates, and therefore, the welds between the metal plates are regions prone to be corroded by the microorganisms in the pressure resistance testing water. The corrosion of the welds is caused by an electrochemical action. The corrosion is accelerated by the microorganisms in the pressure resistance testing water.

In PTL 1 described below, in order to prevent such corrosion caused by the microorganisms, sodium azide is added to the pressure resistance testing water accumulated in the inside of the tank at the time of the pressure resistance testing for the tank.

### CITATION LIST

### Patent Literature

PTL 1: Japanese Patent Publication Laid-open No. S58 (1983)-160834

However, sodium azide may affect a human body. Therefore, it is desired to prevent the corrosion of the welds between the metal plates, which form the tank, without using sodium azide but by using other methods in the pressure resistance testing for the tank.

### SUMMARY

### Technical Problem

In this connection, it is an object of the present disclosure to prevent the welds between the metal plates, which form the tank, from being corroded due to the influence of the microorganisms in the pressure resistance testing water without using sodium azide in a case of injecting the pressure resistance testing water into the tank and performing the pressure resistance testing for the tank.

### Solution to Problem

In order to accomplish the above-mentioned object, according to one aspect of the present disclosure, there is provided a method for preventing tank corrosion at tank pressure resistance testing, the method serving for preventing corrosion of a tank when pressure resistance testing water is injected into the tank to test pressure resistance of the tank against the injected pressure resistance testing water,

wherein an inner surface of the tank is formed by joining a large number of metal plates by welding, and

the method includes:

applying a corrosion inhibitor to welds between the metal plates on a bottom part of the tank before injecting the pressure resistance testing water into an inside of the tank in order to test pressure resistance of the tank; and

making a total bottom part area of the welds to be applied with the corrosion inhibitor on the bottom part of the tank wider than a total non-bottom-part area of the welds to be applied with the corrosion inhibitor on the inner surface of the tank other than the bottom part of the tank.

### Effects

The present disclosure has been made based on the knowledge that a portion where the corrosion occurs in the welds between the metal plates, which form the inner surface of the tank, during the tank pressure resistance testing is the bottom part of the tank. During the pressure resistance testing period for the tank that stores the pressure resistance testing water in the inside of the tank, the microorganisms in the pressure resistance testing water settle to the bottom part of the tank. Hence, on the bottom part of the tank, such a concentration of the microorganisms which corrode the welds on the inner surface of the tank increases. Therefore, during the pressure resistance testing period for the tank, on the bottom part of the tank, the welds on the inner surface of the tank corrode due to the influence of microorganisms. Meanwhile, the microorganisms concentrate on the bottom part of the tank, and accordingly, during the pressure resistance testing period for the tank, the welds on the inner surface of the tank do not corrode or hardly corrode in the portion above the bottom part of the tank.

Based on such knowledge as described above, in the present disclosure, the corrosion inhibitor is applied to the welds between the metal plates on the bottom part of the tank before the pressure resistance testing water is injected into the inside of the tank for the tank pressure resistance testing.

Moreover, the total bottom part area of the welds to be applied with the corrosion inhibitor on the bottom part of the tank is made wider than the total non-bottom-part area of the welds to be applied with the corrosion inhibitor on the inner surface of the tank, the inner surface being other than the bottom part of the tank.

This makes it possible to prevent the corrosion of the welds between the metal plates, which form the tank, over the entire inner surface of the tank without using sodium azide in the pressure resistance testing for the tank.

### BRIEF DESCRIPTION OF DRAWINGS

FIG. 1A shows a tank 10 and auxiliary equipment at the time of tank pressure resistance testing for implementing a method for preventing tank corrosion according to the present disclosure.

FIG. 1B is a cross-sectional view taken along a line B-B of FIG. 1A.

FIG. 10 is a cross-sectional view taken along a line C-C of FIG. 1B.

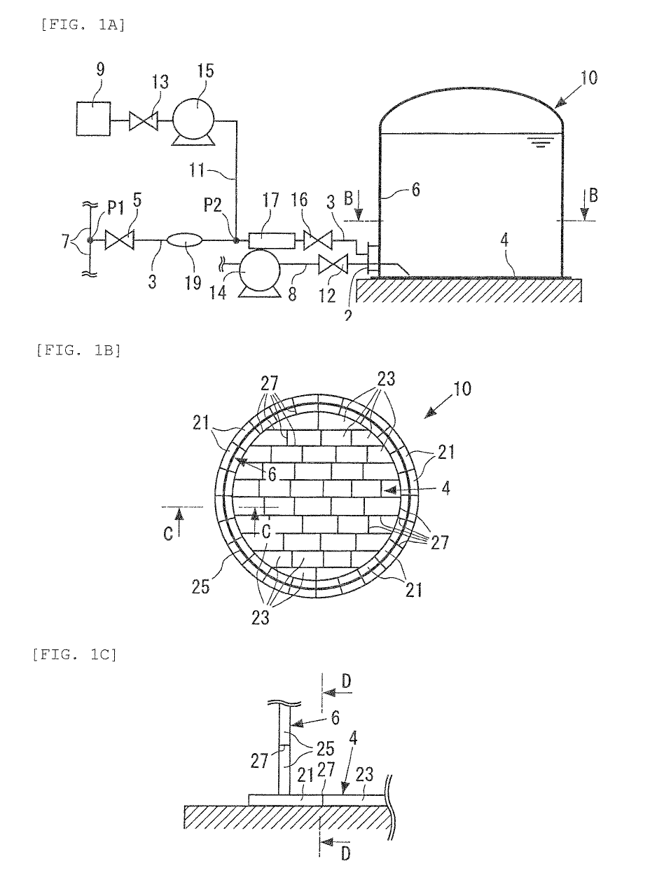

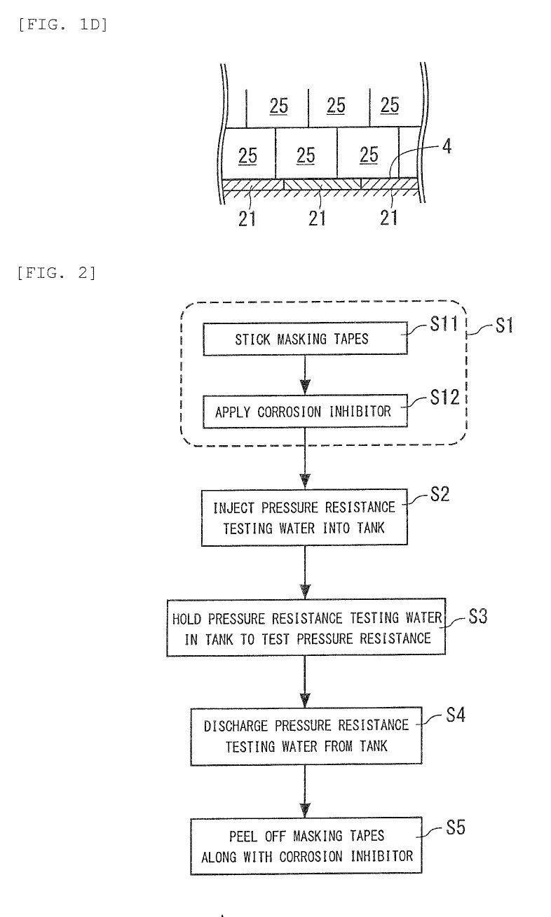

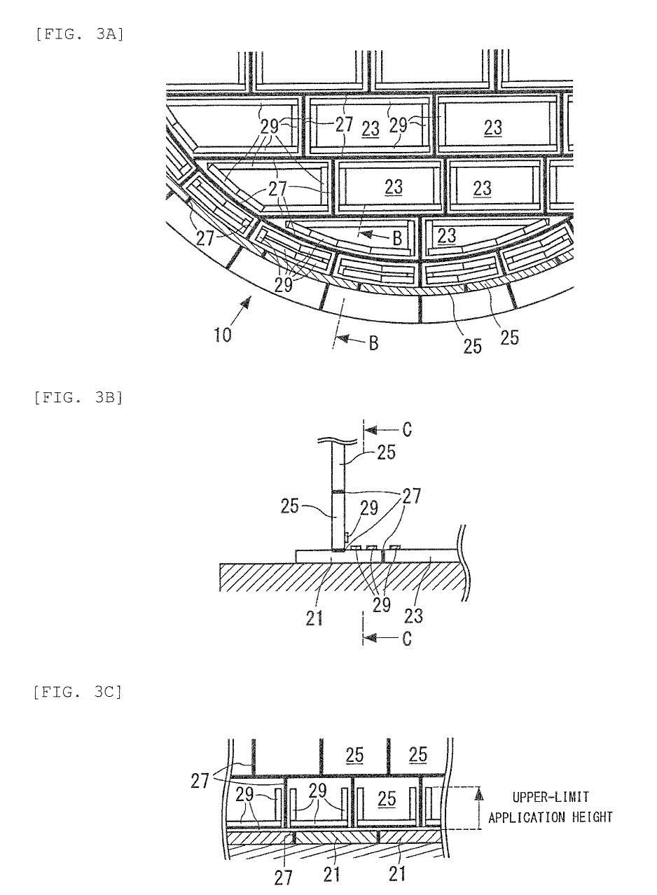

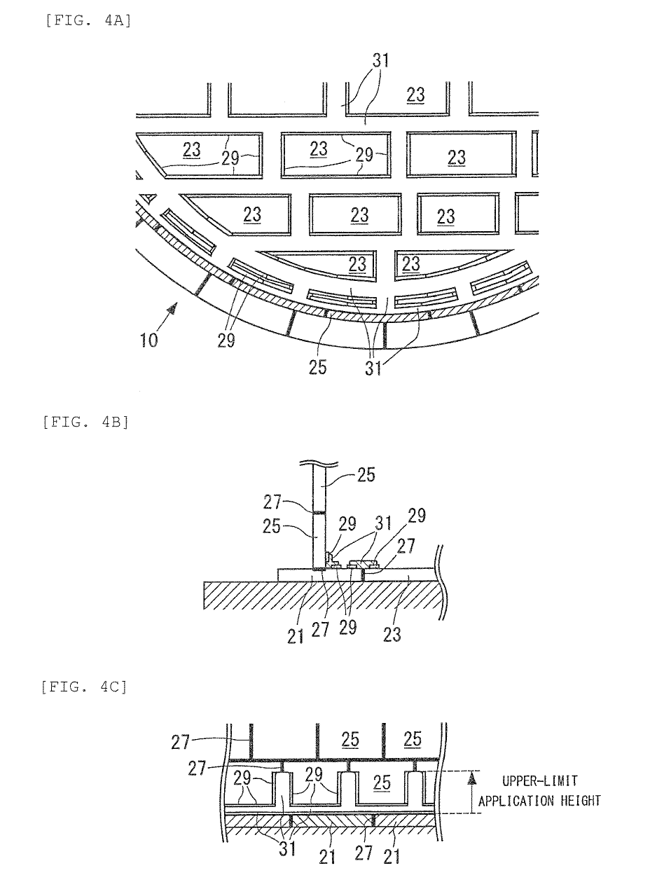

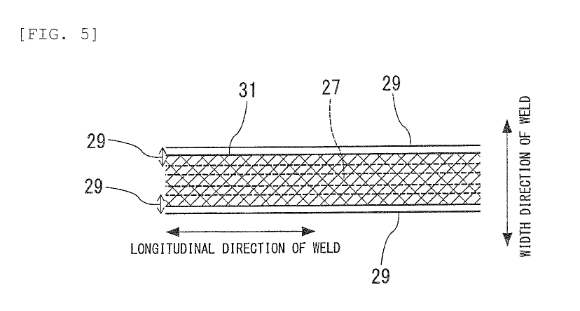

FIG. 1D is a cross-sectional view taken along a line D-D of FIG. 10.

FIG. 2 is a flowchart showing a method for preventing tank corrosion according to an embodiment of the present disclosure.

FIG. 3A corresponds to a partially enlarged view of FIG. 1B showing a state where masking tapes are stuck onto a bottom part of the tank.

FIG. 3B is a cross-sectional view taken along a line B-B of FIG. 3A.

FIG. 3C is a cross-sectional view taken along a line C-C of FIG. 3B.

FIG. 4A corresponds to FIG. 3A showing a state where a corrosion inhibitor is applied to the bottom part of the tank.

FIG. 4B corresponds to FIG. 3B showing the state where the corrosion inhibitor is applied to the bottom part of the tank.

FIG. 4C corresponds to FIG. 3C showing the state where the corrosion inhibitor is applied to the bottom part of the tank.

FIG. 5 is a view illustrating an application range of the corrosion inhibitor.

### DESCRIPTION OF EMBODIMENT

An embodiment of the present disclosure is described based on the drawings. Note that the same reference numerals are assigned to common portions in the respective drawings, and a duplicate description is omitted.

FIG. 1A shows a tank 10 and auxiliary equipment at the time of tank pressure resistance testing for implementing a method for preventing tank corrosion according to the present disclosure. FIG. 1B is a cross-sectional view taken along a line B-B of FIG. 1A, FIG. 10 is a cross-sectional view taken along a line C-C of FIG. 1B, and FIG. 1D is a cross-sectional view taken along a line D-D of FIG. 10.

The tank 10 serves for holding a storage target liquid. The storage target liquid is, for example, liquefied natural gas (LNG). However, the storage target liquid may be a liquid other than the liquefied natural gas. The tank 10 is a large-capacity tank capable of holding 1,000 kiloliters or more (for example, 10,000 kiloliters or more) of the storage target liquid.

As shown in FIG. 1A, in order to perform the tank pressure resistance testing, there is provided an injection pipe 3 for injecting pressure resistance testing water into an inside of the tank 10. In an example of FIG. 1A, the injection pipe 3 injects the pressure resistance testing water into the inside of the tank 10 through a manhole 2 provided in the tank 10. Here, the pressure resistance testing water is different from the storage target liquid mentioned above. For example, the pressure resistance testing water is river water, ground water or seawater, and includes microorganisms which can corrode an inner surface of the tank 10. On-off valves 5 and 16 are provided on the injection pipe 3.

In the example of FIG. 1A, the injection pipe 3 branches off from a branch point P1 of an industrial water pipe 7, and extends to the tank 10. The industrial water pipe 7 is supplied with the river water, the ground water or the seawater as industrial water. Hence, the injection pipe 3 injects the industrial water, which is from the industrial water pipe 7, as the pressure resistance testing water into the inside of the tank 10. However, the pressure resistance testing water may be supplied to the injection pipe 3 without passing through the industrial water pipe 7.

In the example of FIG. 1A, when the on-off valves 5 and 16 are opened, the industrial water is injected as the pressure resistance testing water from the industrial water pipe 7 through the injection pipe 3 into the inside of the tank 10 by a pressure in the industrial water pipe 7.

Moreover, in order to adjust pH of the pressure resistance testing water in the tank 10, a pH adjusting liquid may be introduced into the inside of the tank 10 at the time of the tank pressure resistance testing.

For this purpose, in FIG. 1A, there are provided an adjusting liquid tank 9, an introduction pipe 11, an on-off valve 13, a metering pump 15 and a line mixer 17.

The pH adjusting liquid is held in the adjusting liquid tank 9. The introduction pipe 11 extends from the adjusting liquid tank 9 to the injection pipe 3. The on-off valve 13 is provided in the introduction pipe 11. The metering pump 15 is provided downstream of the on-off valve 13 in the introduction pipe 11. In the injection pipe 3, the line mixer 17 is provided downstream of a junction point P2 where the introduction pipe 11 joins the injection pipe 3.

The metering pump 15 is activated in a state where the on-off valves 13 and 16 are opened, whereby the metering pump 15 supplies the pH adjusting liquid to the inside of the tank 10 through the introduction pipe 11, the junction point P2 and the injection pipe 3. At this time, the pH adjusting liquid passes through the line mixer 17, and in addition, the pressure resistance testing water also passes through the line mixer 17 (for example, from the industrial water pipe 7).

Hence, the pH adjusting liquid and the pressure resistance testing water are mixed with each other in the line mixer 17, and are injected into the inside of the tank 10. Note that an amount of the pH adjusting liquid to be injected into the tank 10 is very slight in comparison with an amount of the pressure resistance testing water to be injected into the tank 10.

The pH adjusting liquid is composed, for example, of an aqueous sodium hydroxide solution and a sodium metasilicate aqueous solution. In this case, the aqueous sodium hydroxide solution with a set concentration (weight %) is prepared by a set amount (volume), and the aqueous sodium metasilicate solution with a set concentration (weight %) is prepared by a set amount (volume), and these aqueous solutions are held in the adjusting liquid tank 9.

Moreover, in the injection pipe 3, a flowmeter 19 is provided upstream of the junction point P2. The flowmeter 19 measures a volumetric flow rate of the pressure resistance testing water that flows from the industrial water pipe 7 to the tank 10.

In FIG. 1A, there is provided a discharge pipe 8 for discharging the pressure resistance testing water, which is injected into the inside of the tank 10, through the manhole 2 to an outside of the tank 10 after the tank pressure resistance testing. An on-off valve 12 is provided on the discharge pipe 8. By opening the on-off valve 12, the pressure resistance testing water in the inside of the tank 10 is discharged through the discharge pipe 8 to the outside of the tank 10. Note that a pump 14 may be provided on the discharge pipe 8. Upon being activated, the pump 14 forcibly discharges the pressure resistance testing water from the inside of the tank 10 to the outside thereof.

As shown in FIG. 1B, FIG. 10 and FIG. 1D, the inner surface of the tank 10 is formed by welding and joining a large number of metal plates 21, 23 and 25 to one another.

A liquid stored in the inside of the tank 10 (i.e., the storage target liquid and the pressure resistance testing water) is bought into direct contact with the inner surface of the tank 10. The respective metal plates 21, 23 and 25 are formed, for example, of aluminum or an aluminum alloy. Oxide films are formed on surfaces of the respective metal plates 21, 23 and 25, and accordingly, regions of the respective metal plates 21, 23 and 25, where the oxide films are present, are not corroded by the microorganisms in the pressure resistance testing water. Meanwhile, the oxide films are not formed on welds 27 between the metal plates. Therefore, the welds 27 between the metal plates 21, 23 and 25 are regions which can be corroded by the microorganisms in the pressure resistance testing water.

In FIG. 1, the large number of metal plates 21 (first metal plates) are annularly arranged on a bottom surface 4 of the tank 10, and form a part of the bottom surface 4. The large number of metal plates 23 (second metal plates) are located inside the metal plates 21 arranged annularly, and form a remaining portion of the bottom surface 4. The large number of metal plates 25 (third metal plates) form an inner peripheral surface 6 of the tank 10.

Hereinafter, the first metal plates 21, the second metal plates 23, and the third metal plates 25 are simply referred to as metal plates 21, 23 and 25 unless distinction therebetween is necessary.

In an example, the bottom surface 4 has a radius of 10 m or more, and the inner peripheral surface 6 has a height of 10 m or more. As described above, the inner surface of the tank 10 includes the bottom surface 4 of the tank 10 and the inner peripheral surface 6 of the tank 10, and the inner peripheral surface 6 surrounds the bottom surface 4, and extends upward from the bottom surface 4.

In a case where the storage target liquid is liquefied natural gas (LNG), the tank 10 has an inner tank and an outer tank. In this case, in FIG. 1, the respective metal plates 21, 23 and 25 form the inner tank, and the outer tank is not shown. The outer tank is disposed outside the inner tank so as to cover the inner tank.

Next, a description is made of the method for preventing tank corrosion at the time of the pressure resistance testing for the tank 10 mentioned above. FIG. 2 is a flowchart showing the method for preventing tank corrosion.

The step S1 is performed before injecting the pressure resistance testing water into the inside of the tank 10. At the step S1, on the bottom part of the tank 10, a corrosion inhibitor 31 is applied by a person to the welds 27 between the metal plates 21, 23 and 25.

Here, the welds 27 present on the bottom part of the tank 10 includes only the welds 27 on the bottom surface 4 and the welds 27 in a region of the inner peripheral surface 6, this region ranging from the bottom surface 4 (an outer peripheral edge of the bottom surface 4) to an upper-limit application height thereof.

Hence, at the step S1, the corrosion inhibitor 31 is applied to the welds 27 (all the welds 27 in this example)present on the bottom surface 4 and the welds 27 (all the welds 27 in this example) present on the inner peripheral surface 6 in the range from the bottom surface 4 to the upper-limit application height. This is because as the welds 27 are present more on the side of bottom surface 4 of the tank 10, it becomes more appropriate to apply the corrosion inhibitor 31 to these welds 27.

Here, the upper-limit application height may be determined based on a size of the tank 10 and other conditions. In an example, the upper-limit application height is a height of 10% or less of an overall height of the tank 10. In another example, the upper-limit application height is a height within a height range of 0.2 m or more to 2.0 m or less.

In this case, the upper-limit application height within the range of 0.2 m or more to 2.0 m or less from the bottom surface 4 is a height within a range reachable by a hand of a person present on the bottom surface 4 of the tank 10. Hence, the corrosion inhibitor 31 can be applied to the welds 27 of the inner peripheral surface 6 easily by the hand of the person present on the bottom surface 4 of the tank 10.

Moreover, corrosion due to the microorganisms can occur in the welds 27 of the inner peripheral surface 6 from the bottom surface 4 to the upper-limit application height in the region within the range of 0.2 m or more to 2.0 m or less. Hence, the corrosion of the welds 27 on the inner peripheral surface 6 of the tank 10 can be prevented by applying the corrosion inhibitor 31 to the welds 27 of the inner peripheral surface 6 in the region from the bottom surface 4 to the upper-limit application height.

In still another example, the upper-limit application height may be a height within a height range of 1.0 m or more to 1.8 m or less, or may be a height within a height range of 1.2 m or more to 1.6 m or less.

Note that the upper-limit application height may differ depending on peripheral positions of the inner peripheral surface 6 of the tank 10, or may be constant regardless of the peripheral positions of the inner peripheral surface 6 of the tank 10.

In the present application, an inner surface of the bottom part of the tank 10 includes only the bottom surface 4 and the region of the inner peripheral surface 6 that ranges from the bottom surface 4 (the outer peripheral edge of the bottom surface 4) to the upper-limit application height. In other words, “the bottom part of the tank 10” stands for the bottom surface 4 and the inner peripheral surface 6 up to the upper-limit application height. Moreover, “other than the bottom part of the tank 10” stands for the inner peripheral surface 6 that is positioned above the upper-limit application height, and a ceiling surface of the tank 10.

A total area A1 (hereinafter, a total bottom part area A1) of the welds 27 to be applied with the corrosion inhibitor 31 on the bottom part of the tank 10 may be made wider than a total area A2 (hereinafter, a total non-bottom-part area A2) of the welds 27 to be applied with the corrosion inhibitor 31 on the inner surface of the tank 10 that is other than the bottom part of the tank 10. The step S1 may be performed in such a manner.

Here, a ratio R=A2/A1 of the total non-bottom-part area A2 to the total bottom part area A1 is for example, 0.1 or less. In this manner, a consumed amount of the corrosion inhibitor 31 can be reduced to a large extent in comparison with a case of applying the corrosion inhibitor 31 to the welds 27 of the entire inner surface of the tank 10.

The ratio R (=A2/A1) described above may be zero. In other words, at the step S1, the welds 27 to be applied with the corrosion inhibitor 31 are only the welds 27 present on the bottom part of the tank 10 among the welds 27 on the entire inner surface of the tank 10. In this manner, the consumed amount of the corrosion inhibitor 31 can be further reduced in comparison with the case of applying the corrosion inhibitor 31 to the welds 27 of the entire inner surface of the tank 10.

Moreover, at the step S1, in a case where there is a jig trace on the bottom surface 4 of the tank 10 and the region of the inner peripheral surface 6 of the tank 10, the region ranging from the bottom surface 4 (the outer peripheral edge of the bottom surface 4) to the upper-limit application height thereof, then the corrosion inhibitor 31 is also applied to this jig trace.

The jig trace is a trace as a result of attaching a hanging piece to each of the metal plates 21, 23 and 25. The hanging piece is attached to each of the metal plates 21, 23 and 25 in order to hoist each of the metal plates 21, 23 and 25 by a heavy machine or another machine. When the hanging piece is detached from each of the metal plates 21, 23 and 25, a trace as a result of attaching the hanging piece is left on the metal plates 21, 23 and 25. This trace is the jig trace.

The step S1 may include the step S11 and the step S12.

FIG. 3A corresponds to a partially enlarged view of FIG. 1B, FIG. 3B is a cross-sectional view taken along a line B-B of FIG. 3A, and FIG. 3C is a cross-sectional view taken along a line C-C of FIG. 3B.

At the step S11, as shown in FIG. 3A, FIG. 3B and FIG. 3C, a masking tape 29 is stuck to the inner surface of the tank 10 along each of all the welds 27 on both sides in a width direction of the weld 27 on the inner surface of the bottom part of the tank 10.

In this case, at the step S11, the masking tapes 29 may be stuck by the person to the inner surface of the tank 10 along the welds 27 on both sides in the width directions of the welds 27 on the inner surface of the bottom part of the tank 10. Note that lower ends of the third metal plates 25 are welded and joined to upper surfaces of the first metal plates 21, and therefore, the welds 27 therebetween extend along the outer peripheral edge of the bottom surface 4. The masking tape 29 is an adhesive tape capable of being peeled off from the inner surface of the tank 10 after being stuck to the inner surface.

FIGS. 4A, 4B and 4C show the tank 10 according to the embodiment of the present disclosure, in which the corrosion inhibitor 31 is applied to the welds 27. FIGS. 4A, 4B and 4C correspond to FIGS. 3A, 3B, and 3C, respectively.

The step S12 is described based on FIGS. 4A, 4B and 4C.

At the step S12, as shown in FIGS. 4A, 4B and 4C, the corrosion inhibitor 31 is applied to an application range including the welds 27 on the inner surface of the bottom part of the tank 10. As shown in FIG. 5, in the width direction of each of the welds 27, this application range extends from a position on the masking tape on one side in this width direction to a position on the masking tape 29 on other side in the width direction, and extends along the weld 27 in a longitudinal direction of the weld 27. In FIG. 5, the application range is indicated by a mesh. By the step S12, the welds 27 are completely covered with the corrosion inhibitor 31 on the inner surface of the bottom part of the tank 10.

Note that, in accordance with the present disclosure, at the step S1, the corrosion inhibitor 31 may be applied to the welds 27 without sticking the masking tape 29 to the inner surface of the tank 10.

The corrosion inhibitor 31 is a fluid, which is applied to the welds 27 and solidified (for example, cured) to form a film. The corrosion inhibitor 31 may be anything as long as the corrosion inhibitor 31 concerned forms a film that prevents the pressure resistance testing water, which is injected into the inside of the tank 10, from reaching the welds 27. The film made of the corrosion inhibitor 31 can be peeled off from the welds 27. The corrosion inhibitor 31 may be anticorrosive paint containing resin as a main component.

In an example, the corrosion inhibitor 31 is Melcoat (registered trademark). Melcoat is a product of Washin Chemical Industry Co., Ltd., and a product code thereof is 73002 in an example. In an example, Melcoat is composed of 0.1 to 1 wt % of methanol, 2.4 wt % of bis(2-ethylhexyl)phthalate, 17.1 wt % toluene, 50 to 60 wt % of methyl ethyl ketone, and appropriate additive and pigment as residues. Here, the additive is, for example, a plasticizer that imparts flexibility and adhesion to the corrosion inhibitor 31.

In another example, the corrosion inhibitor 31 may be anticorrosive paint described in Japanese Patent No. 5346522 and Japanese Patent No. 4150104.

At the step S1, when the corrosion inhibitor 31 applied to the welds 27 is solidified (cured) to form the film, the process proceeds to the step S2.

At the step S2, the pressure resistance testing water is injected into the inside of the tank 10. In the example of FIG. 1, when the on-off valves 5 and 16 are opened, the industrial water as the pressure resistance testing water is sent from the industrial water pipe 7 to the inside of the tank 10 through the injection pipe 3 by a pressure in the industrial water pipe 7. Note that a pump (not shown) may be provided on the injection pipe 3, and this pump may be activated, whereby the pressure resistance testing water is injected from the industrial water pipe 7 through the injection pipe 3 into the inside of the tank 10.

By the step S2, the pressure resistance testing water is stored in the inside of the tank 10. At the step S2, the pressure resistance testing water may be injected into the inside of the tank 10 up to a level from 80% to 100% of a capacity of the tank 10.

At the step S2, in the inside of the tank 10, the set amount of the pH adjusting liquid is injected into the inside of the tank 10. In FIG. 1, not only the on-off valves 5 and 16 but also the on-off valve 13 are opened, and the metering pump 15 is activated. In this manner, the set amount of the pH adjusting liquid is sent from the introduction pipe 11 to the inside of the tank 10 through the injection pipe 3 by the metering pump 15.

The pressure resistance testing water stored in the inside of the tank 10 is made alkaline by the pH adjusting liquid, at the timing that the step S2 is ended. The pH of the pressure resistance testing water stored in the inside of the tank 10 may become a value within a range of 10.0 or more to 10.5 or less at the timing that the step S2 is ended. By such adjustment of the pH, the corrosion of the inner surface (the welds 27 between the metal plates 21, 23 and 25) of the tank 10 is prevented more surely at the step S3 that follows.

Note that the pH adjusting liquid is mixed with the pressure resistance testing water by the line mixer 17, and is supplied to the inside of the tank 10. At the point of time when the step S2 is ended, the volume of the pH adjusting liquid injected into the inside of the tank 10 is slight in comparison with a volume of the pressure resistance testing water injected into the inside of the tank 10 until this timing. At the step S2, the volume of the pressure resistance testing water to be injected into the inside of the tank 10 may be managed by a measurement value by the flowmeter 19.

After the step S2 is completed, the on-off valves 5, 13 and 16 are closed.

At the step S3, the pressure resistance of the tank 10 against the pressure of the pressure resistance testing water stored in the tank 10 at the step S2 is tested. In other words, a state where the pressure resistance testing water is stored in the tank 10 by the step S2 is maintained for a pressure resistance testing period (for example, a period of one month or more to four months or less), and it is tested whether or not the pressure resistance testing water in the tank 10 leaks to the outside of the tank 10 in this pressure resistance testing period. Note that the pressure resistance testing period varies depending on the amount of the pressure resistance testing water supplied into the tank 10, the capacity of the tank 10, and the like.

In the pressure resistance testing period of the step S3, the pressure resistance testing water in the tank 10 is held still without being stirred. In this manner, the microorganisms in the pressure resistance testing water settle and concentrate on the bottom part of the tank 10.

Thereafter, at the step S4, the pressure resistance testing water is discharged from the inside of the tank 10. For example, the on-off valve 12 is opened, whereby the pressure resistance testing water is naturally discharged from the inside of the tank 10 to the outside thereof through the discharge pipe 8 by gravity of the pressure resistance testing water in the inside of the tank 10.

In place to using the gravity of the pressure resistance testing water, or in addition to using the gravity of the pressure resistance testing water, the pump 14 may be activated to discharge the pressure resistance testing water from the inside of the tank 10 to the outside thereof through the discharge pipe 8.

Note that, at the step S4, the pressure resistance testing water in the tank 10 may be neutralized by adding an appropriate acidic liquid to the pressure resistance testing water, and thereafter, the pressure resistance testing water may be discharged from the inside of the tank 10. After the pressure resistance testing water is completely discharged from the inside of the tank 10 by the step S4, the process proceeds to the step S5.

At the step S5, the corrosion inhibitor 31 applied to the inner surface of the tank 10 is peeled off by a person.

In a case where the masking tape 29 is stuck to the inner surface of the tank 10 at the step S1, a person peels off the masking tape 29 and the corrosion inhibitor 31 from the inner surface of the tank 10.

At this time, a person peels off the masking tape 29 from the inner surface of the tank 10 together with the corrosion inhibitor 31 applied to the masking tape 29 and the welds 27. In other words, the corrosion inhibitor 31 is also applied to the masking tape 29 and bonded to the masking tape 29, and accordingly, when the masking tape 29 is peeled off, the corrosion inhibitor 31 is also peeled off from the inner surface (welds 27) of the tank 10 together with the masking tape 29. Hence, the corrosion inhibitor 31 can be easily peeled off from the inner surface of the tank 10.

In other words, the application range of the corrosion inhibitor 31 extends from a position on the masking tape 29 on one side in the width direction of the weld 27 to a position on the masking tape 29 on the other side in the width direction. Accordingly, when the masking tape 29 is peeled off from the inner surface of the tank 10, the corrosion inhibitor 31 applied on the masking tape 29 is peeled off from the inner surface of the tank 10 together with the masking tape 29. In this manner, the corrosion inhibitor 31 can be easily peeled off from the inner surface of the tank 10.

After the step S5 is ended, the pressure resistance testing for the tank 10 is ended.

The present disclosure is not limited to the above-mentioned embodiment, and it is a matter of course that it is possible to add a variety of alterations thereto within the scope without departing from the substance of the present disclosure.

For example, the metal plates 21, 23 and 25 which form the inner surface of the tank 10 may be formed of metal other than the aluminum or the aluminum alloy. In this case, in the metal plates 21, 23 and 25 which form the inner surface of the tank 10, portions other than the welds 27 between the metal plates 21, 23 and 25 are prevented from the occurrence of the corrosion by the oxide film and other films, which are formed on the surfaces of the metal plates 21, 23 and 25.

Moreover, the work of sticking the masking tapes 29 to the inner surface of the tank 10 at the step S11 mentioned above, the work of applying the corrosion inhibitor 31 to the welds 27 at the step S12 mentioned above and the work of peeling off the masking tape 29 and the corrosion inhibitor 31 at the step S5 mentioned above may be carried out by a robot.

According to the present disclosure, the corrosion inhibitor 31 may be applied to the welds 27 between the metal plates 21, 23 and 25 on the bottom part of the tank 10 without using the above-mentioned masking tape 29. In this case, other points are the same as those mentioned above. For example, in the present disclosure, the total bottom part area A1 of the welds 27 applied with the corrosion inhibitor 31 on the bottom part of the tank 10 may be wider than the total non-bottom-part area A2 of the welds 27 applied with the corrosion inhibitor 31 on the inner surface of the tank 10 that is other than the bottom part of the tank 10 (for example, A2/A1 is 0.1 or less). In this case, A2/A1 may be zero.

### REFERENCE SIGNS LIST

A1 total bottom part area
A2 total non-bottom-part area
2 manhole
3 injection pipe
4 bottom surface
5 on-off valve
6 inner peripheral surface
7 industrial water pipe
8 discharge pipe
9 adjusting liquid tank
10 tank
11 introduction pipe
12 on-off valve
13 on-off valve
14 pump
15 metering pump
16 on-off valve
17 line mixer
19 flowmeter
21 first metal plate
23 second metal plate
25 third metal plate
27 weld
29 masking tape
31 corrosion inhibitor

1. A method for preventing tank corrosion at tank pressure resistance testing, the method serving for preventing corrosion of a tank when pressure resistance testing water is injected into the tank to test pressure resistance of the tank against the injected pressure resistance testing water,
wherein an inner surface of the tank is formed by joining a large number of metal plates by welding, and
the method comprises:
applying a corrosion inhibitor to welds between the metal plates on a bottom part of the tank before injecting the pressure resistance testing water into an inside of the tank in order to test pressure resistance of the tank; and
making a total bottom part area of the welds to be applied with the corrosion inhibitor on the bottom part of the tank wider than a total non-bottom-part area of the welds to be applied with the corrosion inhibitor on the inner surface of the tank other than the bottom part of the tank.

2. The method for preventing tank corrosion at tank pressure resistance testing according to claim 1, wherein the welds to be applied with the corrosion inhibitor are only the welds present on the bottom part of the tank among the welds on an entire inner surface of the tank.

3. The method for preventing tank corrosion at tank pressure resistance testing according to claim 1,
wherein the inner surface of the tank comprises a bottom surface of the tank and an inner peripheral surface of the tank, and the inner peripheral surface surrounds the bottom surface and extends upward from the bottom surface, and
the welds present on the bottom part of the tank comprise the welds on the bottom surface and the welds in a region of the inner peripheral surface, the region ranging from the bottom surface to an upper-limit application height of the inner peripheral surface.

4. The method for preventing tank corrosion at tank pressure resistance testing according to claim 2,
wherein the inner surface of the tank comprises a bottom surface of the tank and an inner peripheral surface of the tank, and the inner peripheral surface surrounds the bottom surface and extends upward from the bottom surface, and
the welds present on the bottom part of the tank comprise the welds on the bottom surface and the welds in a region of the inner peripheral surface, the region ranging from the bottom surface to an upper-limit application height of the inner peripheral surface.

5. The method for preventing tank corrosion at tank pressure resistance testing according to claim 1, the method further comprising:
(A) before injecting the pressure resistance testing water into the inside of the tank, sticking masking tapes to the inner surface of the tank along the welds to be applied with the corrosion inhibitor, on both sides in width directions of the welds on the inner surface of the tank;
(B) applying the corrosion inhibitor to an application range including the welds to be applied with the corrosion inhibitor, on the inner surface of the tank, wherein in the width direction of each of the welds, the application range extends from a position on the masking tape on one side in the width direction to a position on the masking tape on other side in the width direction, and extends along the weld in a longitudinal direction of the weld;
(C) injecting the pressure resistance testing water into the inside of the tank;
(D) holding the pressure resistance testing water in the inside of the tank for a pressure resistance testing period;
(E) discharging the pressure resistance testing water from the inside of the tank; and
(F) peeling off the masking tape and the corrosion inhibitor from the inner surface of the tank.

6. The method for preventing tank corrosion at tank pressure resistance testing according to claim 2, the method further comprising:
(A) before injecting the pressure resistance testing water into the inside of the tank, sticking masking tapes to the inner surface of the tank along the welds to be applied with the corrosion inhibitor, on both sides in width directions of the welds on the inner surface of the tank;
(B) applying the corrosion inhibitor to an application range including the welds to be applied with the corrosion inhibitor, on the inner surface of the tank, wherein in the width direction of each of the welds, the application range extends from a position on the masking tape on one side in the width direction to a position on the masking tape on other side in the width direction, and extends along the weld in a longitudinal direction of the weld;
(C) injecting the pressure resistance testing water into the inside of the tank;
(D) holding the pressure resistance testing water in the inside of the tank for a pressure resistance testing period;
(E) discharging the pressure resistance testing water from the inside of the tank; and
(F) peeling off the masking tape and the corrosion inhibitor from the inner surface of the tank.

7. The method for preventing tank corrosion at tank pressure resistance testing according to claim 3, the method further comprising:
(A) before injecting the pressure resistance testing water into the inside of the tank, sticking masking tapes to the inner surface of the tank along the welds to be applied with the corrosion inhibitor, on both sides in width directions of the welds on the inner surface of the tank;
(B) applying the corrosion inhibitor to an application range including the welds to be applied with the corrosion inhibitor, on the inner surface of the tank, wherein in the width direction of each of the welds, the application range extends from a position on the masking tape on one side in the width direction to a position on the masking tape on other side in the width direction, and extends along the weld in a longitudinal direction of the weld;
(C) injecting the pressure resistance testing water into the inside of the tank;
(D) holding the pressure resistance testing water in the inside of the tank for a pressure resistance testing period;
(E) discharging the pressure resistance testing water from the inside of the tank; and
(F) peeling off the masking tape and the corrosion inhibitor from the inner surface of the tank.

8. The method for preventing tank corrosion at tank pressure resistance testing according to claim 4, the method further comprising:
(A) before injecting the pressure resistance testing water into the inside of the tank, sticking masking tapes to the inner surface of the tank along the welds to be applied with the corrosion inhibitor, on both sides in width directions of the welds on the inner surface of the tank;
(B) applying the corrosion inhibitor to an application range including the welds to be applied with the corrosion inhibitor, on the inner surface of the tank, wherein in the width direction of each of the welds, the application range extends from a position on the masking tape on one side in the width direction to a position on the masking tape on other side in the width direction, and extends along the weld in a longitudinal direction of the weld;
(C) injecting the pressure resistance testing water into the inside of the tank;
(D) holding the pressure resistance testing water in the inside of the tank for a pressure resistance testing period;
(E) discharging the pressure resistance testing water from the inside of the tank; and
(F) peeling off the masking tape and the corrosion inhibitor from the inner surface of the tank.
